(19) United States
(12) Patent Application Publication
(10) Pub. No.: US 2024/0378658 A1
(43) Pub. Date: Nov. 14, 2024

(54) ORDER PLACEMENT/ORDER ACCEPTANCE SYSTEM, ORDER PLACEMENT DEVICE, AND ORDER PLACEMENT METHOD

(71) Applicant: TOYOTA JIDOSHA KABUSHIKI KAISHA, Toyota-shi (JP)

(72) Inventors: Kento IWAHORI, Nagoya-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/643,084

(22) Filed: Apr. 23, 2024

(30) Foreign Application Priority Data
May 11, 2023 (JP) 2023-078320

(51) Int. Cl. G06Q 30/0601; B62D 65/18; G05D 1/227; G05D 107/70

(52) U.S. Cl. CPC G06Q 30/0633; B62D 65/18; G05D 1/227; G05D 2107/70

(57) ABSTRACT

An order placement/order acceptance system includes: an order placement device that places an order of a moving object moved by remote control in manufacturing process; and an order acceptance device that accepts order of the moving object. The order placement device includes display control unit that causes display device to display an order screen for accepting order of moving object, and enables selection of whether to desire delivery of moving object in an enabled state where remote control is accepted or to desire the delivery of the moving object in a disabled state where remote control is not accepted, and a transmission unit that transmits order information including contents selected via order screen. The order acceptance device includes a reception unit that receives the order information, and a disabling command unit that transmits to the moving object a disabling command for switching the enabled state to the disabled state.

### CROSS REFERENCE TO RELATED APPLICATIONS

This application claims priority to Japanese Patent Application No. 2023-078320, filed May 11, 2023, the disclosure of which is incorporated by reference herein in its entirety.

### BACKGROUND

### Field

The present disclosure relates to an order placement/order acceptance system, an order placement device, and an order placement method.

There is known a technique of causing a vehicle to run by remote control in a vehicle manufacturing process (for example, Japanese Patent Application Publication (Translation of PCT Application) No. 2017-538619).

Whether a client desires delivery of a moving object in a state where a remote control function used in the manufacturing process is enabled or desires delivery of the moving object in a state where the remote control function is disabled differs per client. Hence, there is desired a technique for providing moving objects in states that meet clients' demands to clients.

### SUMMARY

The present disclosure can be implemented as a following aspect.

(1) A first aspect of the present disclosure provides an order placement/order acceptance system. This order placement/order acceptance system includes: an order placement device configured to place an order of a moving object that is moved by remote control in a manufacturing process of the moving object; and an order acceptance device configured to accept an order of the moving object, wherein the order placement device includes a display control unit and a transmission unit, wherein the display control unit is configured to cause a display device to display an order screen for accepting the order of the moving object, wherein the order screen enables selection of whether to desire delivery of the moving object in an enabled state or to desire the delivery of the moving object in a disabled state, wherein the enabled state is a state that the remote control is accepted, wherein the disabled state is a state that the remote control is not accepted, and wherein the transmission unit is configured to transmit order information including contents selected via the order screen, and wherein the order acceptance device includes a reception unit and a disabling command unit, wherein the reception unit is configured to receive the order information, and wherein the disabling command unit is configured to transmit to the moving object a disabling command for switching the enabled state to the disabled state, wherein when the order information indicates that the delivery of the moving object in the disabled state is desired, the disabling command unit transmits to the moving object the disabling command.

According to the order placement/order acceptance system according to this aspect, it is possible to display the order screen that enables selection of whether to desire delivery of the moving object in the state where the remote control is enabled or to desire the delivery of the moving object in the state where the remote control is disabled. Consequently, it is possible to provide moving objects in states that meet clients' demands to clients.

(2) In the order placement/order acceptance system according to the above aspect, when the delivery of the moving object in the enabled state is selected, the display control unit may enable selection of whether or not to order a remote control device that remotely controls the moving object on the order screen.

According to the order placement device according to this aspect, it is possible to provide a control device for remotely controlling the moving object to clients who desire delivery of the moving objects in the state where the remote control is enabled.

(3) In the order placement/order acceptance system according to the above aspect, the moving object may include a disabling execution unit configured to switch the enabled state to the disabled state, wherein when a predetermined condition including reception of the disabling command is satisfied, disabling execution unit switches the enabled state to the disabled state.

According to the order placement/order acceptance system according to this aspect, it is possible to automatically switch the moving object from the enabled state to the disabled state by transmitting the disabling command to the moving object.

(4) In the order placement/order acceptance system according to the above aspect, the order acceptance device may further include a determination unit configured to determine whether or not to accept the order placement of the moving object, wherein when the order information indicates that the delivery of the moving object in the enabled state is desired, the determination unit determines whether or not to accept the order placement of the moving object.

According to the order placement/order acceptance system according to this aspect, it is possible to determine whether or not to accept the order placement of the moving object in the enabled state.

(5) In the order placement/order acceptance system according to the above aspect, the determination unit may determine whether or not to accept the order placement of the moving object using information related to a client who purchases the moving object.

According to the order placement/order acceptance system according to this aspect, it is possible to determine whether or not to accept the order placement of the moving object in the enabled state using the information related to the client who purchases the moving object.

(6) In the order placement/order acceptance system according to the above aspect, the order acceptance device may further include a storage unit configured to store a database related to a client for whom the delivery of the moving object in the enabled state is permitted, and the determination unit may determine whether or not to accept the order placement of the moving object using the database.

According to the order placement/order acceptance system according to this aspect, it is possible to determine whether or not to accept the order placement of the moving object in the enabled state using the database.

(7) In the order placement/order acceptance system according to the above aspect, when determining not to accept the order placement of the moving object, the determination unit may transmit, to the order placement device, information indicating that the order placement of the moving object is not accepted.

According to the order placement/order acceptance system according to this aspect, it is possible to notify an orderer of that order placement of the moving object in the enabled state is not accepted.

(8) In the order placement/order acceptance system according to the above aspect, when receiving the disabling command and then detecting that the moving object is located in a predetermined area, the disabling execution unit may switch the enabled state to the disabled state.

According to the order placement/order acceptance system according to this aspect, it is possible to disable remote control of the moving object when the moving object is located in the predetermined area.

(9) In the order placement/order acceptance system according to the above aspect, the disabling execution unit may switch the enabled state to the disabled state at a timing at which a predetermined period passes after the disabling command is received.

According to the order placement/order acceptance system according to this aspect, it is possible to adjust a timing at which remote control of the moving object is disabled.

(10) In the order placement/order acceptance system according to the above aspect, when receiving the disabling command and then detecting an electromagnetic wave of a predetermined wavelength, the disabling execution unit may switch the enabled state to the disabled state.

According to the order placement/order acceptance system according to this aspect, it is possible to disable remote control of the moving object at a timing at which the electromagnetic wave of the predetermined wavelength is emitted.

(11) In the order placement/order acceptance system according to the above aspect, when receiving the disabling command and then detecting that another moving object located in surroundings of the moving object has been switched from the enabled state to the disabled state, the disabling execution unit may switch the enabled state to the disabled state.

According to the order placement/order acceptance system according to this aspect, remote control of the moving object is disabled at a timing at which remote control of the another moving object located in the surroundings of the moving object is disabled, so that it is also possible to disable the remote control of the another moving object located in the surroundings by disabling remote control of one moving object.

(12) A second aspect of the present disclosure provides an order placement device that places an order of a moving object that is moved by remote control in a manufacturing process of the moving object. This order placement device includes: a display control unit configured to cause a display device to display an order screen for accepting the order of the moving object, wherein the order screen enables selection of whether to desire delivery of the moving object in an enabled state or to desire the delivery of the moving object in a disabled state, wherein the enabled state is a state that the remote control is accepted, wherein the disabled state is a state that the remote control is not accepted; and a transmission unit configured to transmit order information including contents selected via the order screen to an order acceptance device that accepts the order of the moving object.

According to the order placement device according to this aspect, it is possible to display the order screen that enables selection of whether to desire delivery of the moving object in the state where the remote control is enabled or to desire the delivery of the moving object in the state where the remote control is disabled. Consequently, it is possible to provide moving objects in states that meet clients' demands to clients.

(13) A third aspect of the present disclosure provides a computer-readable recording medium having a computer program recorded thereon. In this recording medium, the computer program causes a computer to implement: a function of causing a display device to display an order screen for accepting an order of a moving object that is moved by remote control in a manufacturing process of the moving object, wherein the order screen enables selection of whether to desire delivery of the moving object in an enabled state where the remote control is accepted or to desire the delivery of the moving object in a disabled state where the remote control is not accepted; and a function of transmitting order information including contents selected via the order screen to an order acceptance device that accepts the order of the moving object.

According to the recording medium according to this aspect, it is possible to display the order screen that enables selection of whether to desire delivery of the moving object in the state where the remote control is enabled or to desire the delivery of the moving object in the state where the remote control is disabled. Consequently, it is possible to provide moving objects in states that meet clients' demands to clients.

(14) A fourth aspect of the present disclosure provides a graphical user interface that accepts an order of a moving object that is moved by remote control in a manufacturing process of the moving object. This graphical user interface includes a button for selecting whether to desire delivery of the moving object in an enabled state where the remote control is accepted or to desire the delivery of the moving object in a disabled state where the remote control is not accepted.

According to the graphical user interface according to this aspect, it is possible to display the order screen that enables selection of whether to desire delivery of the moving object in the state where the remote control is enabled or to desire the delivery of the moving object in the state where the remote control is disabled. Consequently, it is possible to provide moving objects in states that meet clients' demands to clients.

(15) A fifth aspect of the present disclosure provides an order placement method for placing an order of a moving object that is moved by remote control in a manufacturing process of the moving object. This order placement device includes: causing a display device to display an order screen for accepting the order of the moving object, wherein the order screen enables selection of whether to desire delivery of the moving object in an enabled state or to desire the delivery of the moving object in a disabled state, wherein the enabled state is a state that the remote control is accepted, wherein the disabled state is a state that the remote control is not accepted; and transmitting order information including contents selected via the order screen to an order acceptance device that accepts the order of the moving object.

According to the order acceptance method according to this aspect, it is possible to display the order screen that enables selection of whether to desire delivery of the moving object in the state where the remote control is enabled or to desire the delivery of the moving object in the state where the remote control is disabled. Consequently, it is possible to provide moving objects in states that meet clients' demands to clients.

The present disclosure can be also implemented as various aspects other than the order placement device, the order placement/order acceptance system, the recording medium, the graphical user interface, and the order placement method. For example, the present disclosure can be implemented as aspects such as an order placement/order acceptance method.

### BRIEF DESCRIPTION OF DRAWINGS

FIG. 1 is an explanatory view illustrating a configuration of an order placement/order acceptance system;

FIG. 2 is an explanatory view illustrating configurations of a vehicle and a remote control device;

FIG. 3A is an explanatory view illustrating how the vehicle is moved by remote control;

FIG. 3B is a flowchart illustrating a procedure of running control of the vehicle;

FIG. 4 is a first explanatory view illustrating a configuration of an order screen;

FIG. 5 is a second explanatory view illustrating the configuration of the order screen;

FIG. 6 is a flowchart illustrating contents of order placement processing;

FIG. 7 is a flowchart illustrating contents of order acceptance processing;

FIG. 8 is a flowchart illustrating contents of disabling execution processing; and

FIG. 9 is an explanatory view schematically illustrating how the vehicle is ordered and delivered.

### DETAILED DESCRIPTION

### A. First Embodiment

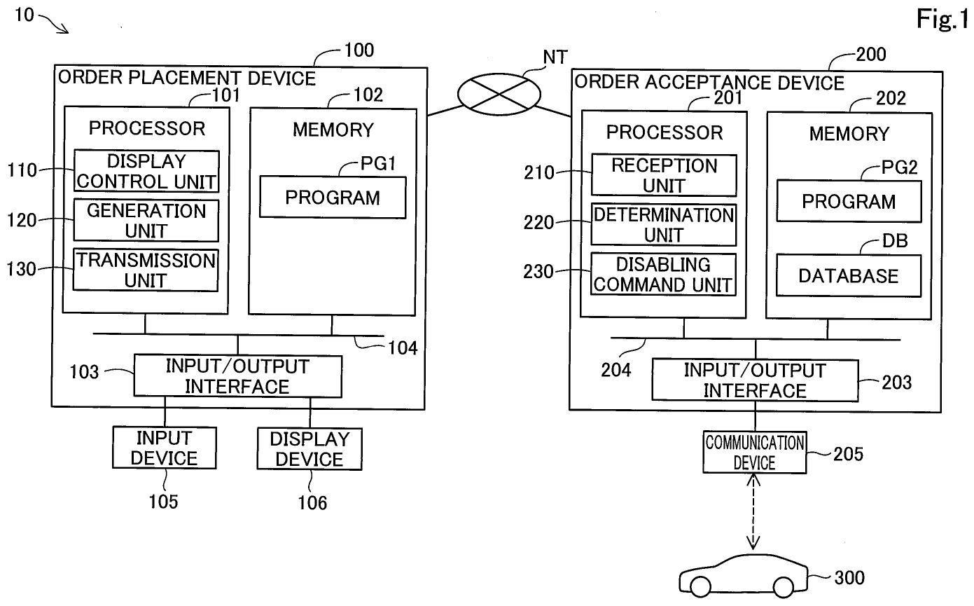

FIG. 1 is an explanatory view illustrating a configuration of an order placement/order acceptance system 10 according to the first embodiment. The order placement/order acceptance system 10 includes an order placement device 100 that places orders of products, and an order acceptance device 200 that accepts orders of products. The order placement device 100 and the order acceptance device 200 are connected via a network NT. In the present embodiment, the product is a moving object. The moving object is a vehicle 300 that is configured to be able to be moved by unmanned driving.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a track, a bus, a two-wheel vehicle, a four-wheel vehicle, a construction vehicle, or a combat vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 300 are completely determined from outside the vehicle 300, and “partial remote control” by which some of the motions of the vehicle 300 are determined from outside the vehicle 300. The “autonomous control” includes “complete autonomous control” by which the vehicle 300 controls a motion of the vehicle 300 autonomously without receiving any information from a device outside the vehicle 300, and “partial autonomous control” by which the vehicle 300 controls a motion of the vehicle 300 autonomously using information received from a device outside the vehicle 300.

In the present embodiment, the order placement device 100 is disposed at a dealer that sells the vehicle 300, and is operated by a salesperson of the dealer. The order placement device 100 is configured as a computer that includes a processor 101, a memory 102, an input/output interface 103, and an internal bus 104. The processor 101, the memory 102, and the input/output interface 103 are bidirectionally communicably connected via the internal bus 104. The input/output interface 103 is connected with an input device 105 and a display device 106. The input device 105 is, for example, a keyboard or a mouse, and the display device 106 is, for example, a liquid crystal display. The input device 105 and the display device 106 may be integrated as a touch panel. The memory 102 stores a computer program PG1.

The processor 101 functions as a display control unit 110, a generation unit 120, and a transmission unit 130 by executing the computer program PG1. The display control unit 110 causes the display device 106 to display an order screen for accepting input of an order. The salesperson can input order contents from a client to the order screen using the input device 105. The generation unit 120 generates order information including the order contents input to the order screen. In the present embodiment, the order information includes the order contents, information related to the client, identification information of the dealer, and identification information of the salesperson who has input the order contents. The transmission unit 130 transmits the order information to the order acceptance device 200.

In the present embodiment, the order acceptance device 200 is disposed at a factory that manufactures the vehicle 300. The order acceptance device 200 manages manufacturing of the vehicle 300 in the factory according to the order contents indicated in the order information. The order acceptance device 200 is configured as a computer that includes a processor 201, a memory 202, an input/output interface 203, and an internal bus 204. The processor 201, the memory 202, and the input/output interface 203 are bidirectionally communicably connected via the internal bus 204. The input/output interface 203 is connected with a communication device 205 that communicates with the vehicle 300 by wireless communication. The memory 202 stores a computer program PG2 and a database DB. In the database DB, information related to clients who have purchase records of products of a manufacturer of the vehicle 300 is recorded. Note that the memory 202 is also referred to as a storage unit.

The processor 201 functions as a reception unit 210, a determination unit 220, and a disabling command unit 230 by executing the computer program PG2. The reception unit 210 receives the order information transmitted from the order placement device 100. The determination unit 220 determines using the order information whether or not to deliver the vehicle 300 in a state where a remote control function of the vehicle 300 is enabled. The remote control function of the vehicle 300 refers to a function of running by being remotely controlled from an outside. The remote control function is used in a manufacturing process of the vehicle 300. The disabling command unit 230 transmits to the vehicle 300 a disabling command for disabling the remote control function of the vehicle 300 according to a determination result of the determination unit 220.

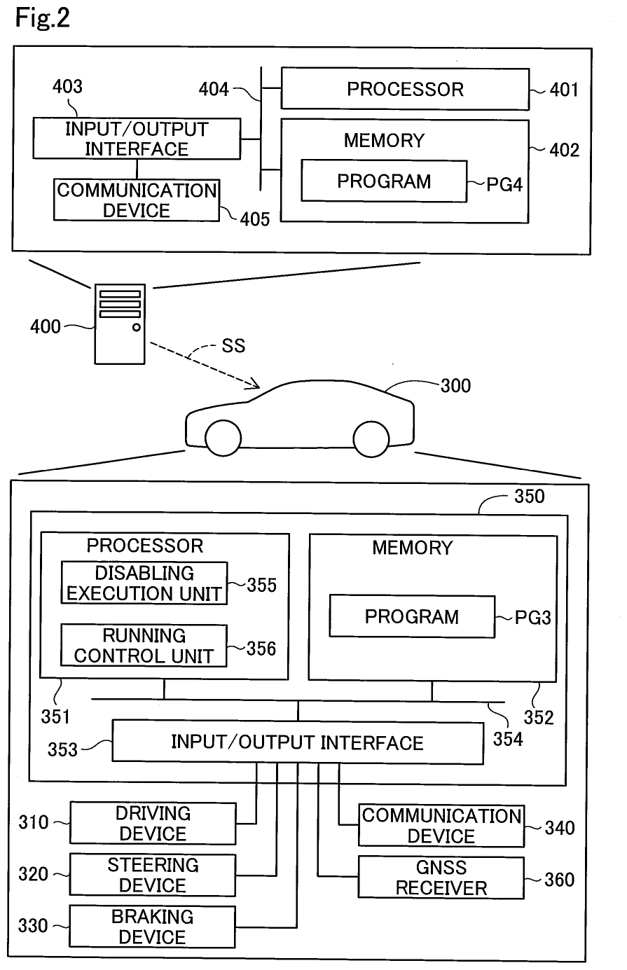

FIG. 2 is an explanatory view illustrating the configurations of the vehicle 300 and a remote control device 400. The vehicle 300 is configured to be able to be moved by remote control from the remote control device 400. More specifically, the vehicle 300 includes a driving device 310 that accelerates the vehicle 300, a steering device 320 that changes a traveling direction of the vehicle 300, a braking device 330 that decelerates the vehicle 300, a communication device 340 that communicates with the remote control device 400 by wireless communication, a vehicle control device 350 that controls each unit of the vehicle 300, and a Global Navigation Satellite System (GNSS) receiver 360 that acquires position information of the vehicle 300. In the present embodiment, the communication device 340 can also communicate with the order acceptance device 200 by wireless communication. The driving device 310 includes a battery, a motor that is driven using power of the battery, and driving wheels that are rotated by the motor.

The vehicle control device 350 is configured as a computer that includes a processor 351, a memory 352, an input/output interface 353, and an internal bus 354. The processor 351, the memory 352, and the input/output interface 353 are bidirectionally communicably connected via the internal bus 354. The input/output interface 353 is connected with the driving device 310, the steering device 320, the braking device 330, the communication device 340, and the GNSS receiver 360.

The processor 351 functions as a disabling execution unit 355 and a running control unit 356 by executing a computer program PG3 stored in advance in the memory 352. The disabling execution unit 355 switches an operation state of the vehicle control device 350 from an enabled state where a remote control command SS is accepted to a disabled state where the remote control command SS is not accepted. The running control unit 356 executes running control of the vehicle 300. “Running control” refers to, for example, adjustment of an acceleration, a speed, and a steering angle of the vehicle 300. The running control unit 356 causes the vehicle 300 to run by executing running control, in other words, by controlling the driving device 310, the steering device 320, and the braking device 330. The running control unit 356 can cause the vehicle 300 to run by controlling the various devices 310 to 330 in response to a passenger's operation when the passenger is in the vehicle 300. When the operation state of the vehicle control device 350 is the enabled state, the running control unit 356 can cause the vehicle 300 to run by controlling the various devices 310 to 330 in response to the remote control command SS received from the remote control device 400 irrespectively of whether or not the passenger is in the vehicle 300.

The vehicle control device 400 is configured as a computer that includes a processor 401, a memory 402, an input/output interface 403, and an internal bus 404. The processor 401, the memory 402, and the input/output interface 403 are bidirectionally communicably connected via the internal bus 404. The input/output interface 403 is connected with a communication device 405 that communicates with the vehicle 300 and cameras CM to be described later by wireless communication. The communication device 405 may communicate with the vehicle 300 by wireless communication, and communicate with the cameras CM by wired communication. The processor 401 remotely controls the vehicle 300 by executing a computer program PG4 stored in advance in the memory 402.

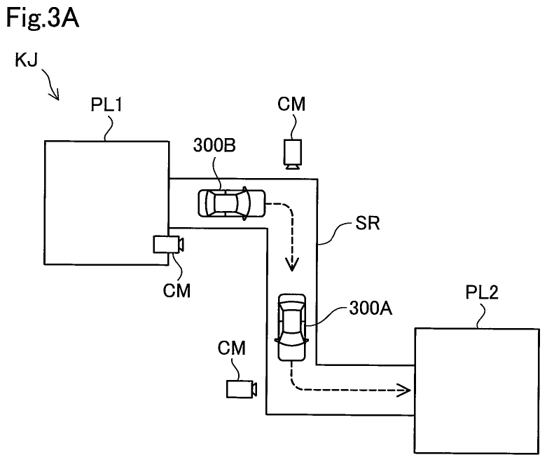

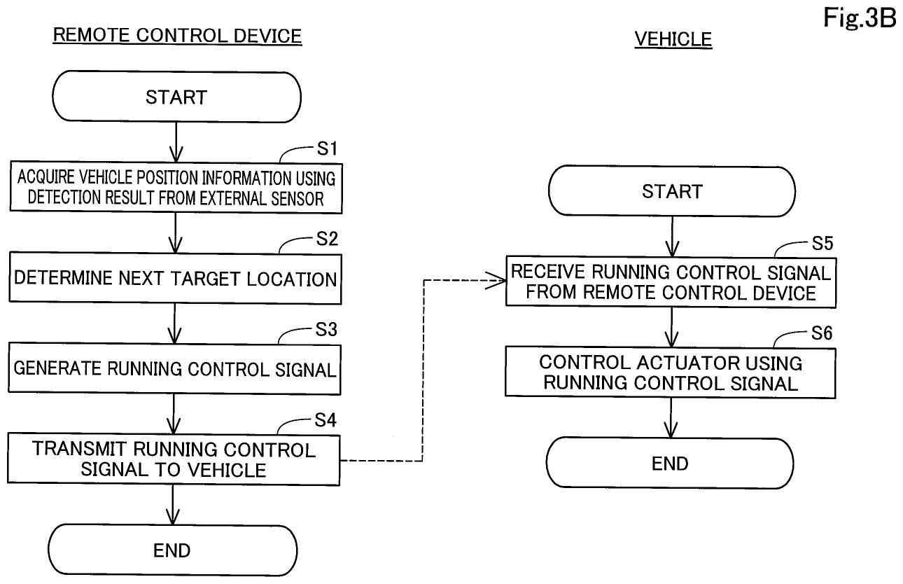

FIG. 3A is an explanatory view illustrating how the vehicle 300 is run by remote control in a factory KJ. FIG. 3A illustrates two vehicles 300A and 300B. In the following description, in a case where the vehicles 300A and 300B do not need to be distinguished, the vehicles 300A and 300B will be referred to simply as the vehicles 300. In the present embodiment, the factory KJ that manufactures the vehicles 300 includes a first place PL1 for performing assembly work of the vehicles 300, and a second place PL2 for inspecting the vehicles 300. The first place PL1 and the second place PL2 are connected by a track SR on which the vehicles 300 can run. The vehicle 300 is moved from the first place PL1 to the second place PL2 by remote control from the remote control device 400. The remote control device 400 determines a target route for the vehicle 300 to run toward a destination through the track SR. In the present embodiment, the target route refers to a reference route to be described later. A plurality of the cameras CM that shoot the track SR are installed in the factory KJ, and the remote control device 400 can acquire a relative position and orientation of the vehicle 300 with respect to the target route in real time by analyzing a video shot by each camera CM. The remote control device 400 generates a remote control command for causing the vehicle 300 to run along the target route, and transmits the remote control command to the vehicle 300. In the present embodiment, the remote control command refers to the a running control signal to be described later. The vehicle control device 350 mounted on the vehicle 300 can cause the vehicle 300 to run by controlling the driving device 310, the steering device 320, and the braking device 330 according to the received remote control command. Consequently, it is possible to move the vehicle 300 by remote control from the first place PL1 to the second place PL2 without using a conveyance device such as a crane or a conveyor. In the present embodiment, the remote control device 400 can cause a plurality of the vehicles 300A and 300B simultaneously in parallel by remote control.

FIG. 3B is a flowchart showing a processing procedure for running control of the vehicle 300 in the first embodiment. In step S1, the remote control device 400 acquires vehicle location information using detection result output from an external sensor. The external sensor is located outside the vehicle 300. The vehicle location information is locational information as a basis for generating a running control signal. In the present embodiment, the vehicle location information includes the location and orientation of the vehicle 300 in a reference coordinate system of the factory KJ. In the present embodiment, the reference coordinate system of the factory KJ is a global coordinate system and a location in the factory KJ can be expressed by X, Y, and Z coordinates in the global coordinate system. In the present embodiment, the external sensor is a camera CM that is disposed in the factory KJ and outputs a captured image as detection result. In step S1, the remote control device 400 acquires the vehicle location information using the captured image acquired from the camera CM as the external sensor.

More specifically, in step S1, the remote control device 400 for example, determines the outer shape of the vehicle 300 from the captured image, calculates the coordinates of a positioning point of the vehicle 300 in a coordinate system of the captured image, namely, in a local coordinate system, and converts the calculated coordinates to coordinates in the global coordinate system, thereby acquiring the location of the vehicle 300. The outer shape of the vehicle 300 in the captured image may be detected by inputting the captured image to a detection model using artificial intelligence, for example. The detection model is prepared in the order placement/order acceptance system 10 or outside the order placement/order acceptance system 10. The detection model is stored in advance in a memory 402 of the remote control device 400, for example. An example of the detection model is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 300, and a label showing whether each region in the training image is a region indicating the vehicle 300 or a region indicating a subject other than the vehicle 300, for example. In training the CNN, a parameter for the CNN is preferably updated through backpropagation in such a manner as to reduce error between output result obtained by the detection model and the label. The remote control device 400 can acquire the orientation of the vehicle 300 through estimation based on the direction of a motion vector of the vehicle 300 detected from change in location of a feature point of the vehicle 300 between frames of the captured images using optical flow process, for example.

In step S2, the remote control device 400 determines a target location to which the vehicle 300 is to move next. In the present embodiment, the target location is expressed by X, Y, and Z coordinates in the global coordinate system. The memory 202 of the remote control device 400 contains a reference route stored in advance as a route along which the vehicle 300 is to run. The route is expressed by a node indicating a departure place, a node indicating a way point, a node indicating a destination, and a link connecting nodes to each other. The remote control device 400 determines the target location to which the vehicle 300 is to move next using the vehicle location information and the reference route. The remote control device 400 determines the target location on the reference route ahead of a current location of the vehicle 300.

In step S3, the remote control device 400 generates a running control signal for causing the vehicle 300 to run toward the determined target location. In the present embodiment, the running control signal includes an acceleration and a steering angle of the vehicle 300 as parameters. The remote control device 400 calculates a running speed of the vehicle 300 from transition of the location of the vehicle 300 and makes comparison between the calculated running speed and a target speed of the vehicle 300 determined in advance. If the running speed is lower than the target speed, the remote control device 400 generally determines an acceleration in such a manner as to accelerate the vehicle 300. If the running speed is higher than the target speed as, the remote control device 400 generally determines an acceleration in such a manner as to decelerate the vehicle 300. If the vehicle 300 is on the reference route, remote control device 400 determines a steering angle and an acceleration in such a manner as to prevent the vehicle 300 from deviating from the reference route. If the vehicle 300 is not on the reference route, in other words, if the vehicle 300 deviates from the reference route, the remote control device 400 determines a steering angle and an acceleration in such a manner as to return the vehicle 300 to the reference route. In other embodiments, the running control signal may include the speed of the vehicle 300 as a parameter instead of or in addition to the acceleration of the vehicle 300.

In step S4, the remote control device 400 transmits the generated running control signal to the vehicle 300. The remote control device 400 repeats the acquisition of vehicle location information, the determination of a target location, the generation of a running control signal, the transmission of the running control signal, and others in a predetermined cycle.

In step S5, the vehicle control device 350 of the vehicle 300 receives the running control signal transmitted from the remote control device 400. In step S6, the vehicle control device 350 controls the driving device 310, the steering device 320, and the braking device using the received running control signal, thereby causing the vehicle 300 to run at the acceleration and the steering angle indicated by the running control signal. The vehicle control device 350 repeats the reception of a running control signal and the control over the driving device 310, the steering device 320, and the braking device in a predetermined cycle.

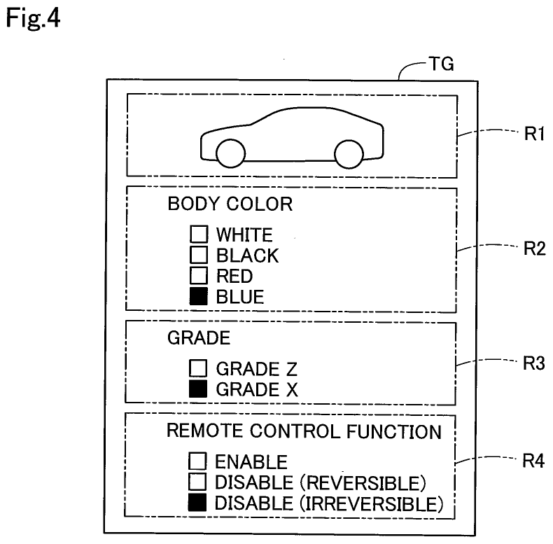

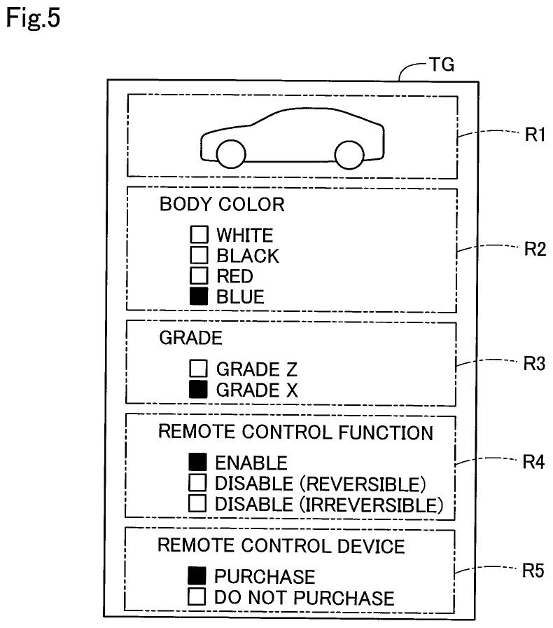

FIG. 4 is a first explanatory view illustrating a configuration of an order screen TG. FIG. 5 is a second explanatory view illustrating the configuration of the order screen TG. The order screen TG is a graphical user interface that accepts orders. As illustrated in FIG. 4, the order screen TG includes an image display area R1, a body color selection area R2, a grade selection area R3, and a remote control function selection area R4. The image display area R1 displays an image of the vehicle 300. The body color selection area R2 displays buttons for selecting a body color of the vehicle 300. The grade selection area R3 displays buttons for selecting the grade of the vehicle 300. The remote control function selection area R4 displays buttons for selecting the state of the remote control function of the vehicle 300 at a time of delivery to a dealer. The salesperson can select the body color, the grade, and the state of the remote control function of a vehicle to order by operating the input device 105 and pushing each button displayed on the order screen TG.

In the present embodiment, the state of the remote control function of the vehicle 300 at the time of delivery can be selected from three of “enable”, “disable (reversible)”, and “disable (irreversible)”. In a case where “enable” is selected, the vehicle 300 is delivered in a state where the remote control function of the vehicle 300 is enabled. In a case where “disable (reversible)” is selected, the vehicle 300 is delivered in a state where the remote control function of the vehicle 300 is reversibly disabled. In a case where “disable (irreversible)” is selected, the vehicle 300 is delivered in a state where the remote control function of the vehicle 300 is irreversibly disabled. The reversibly disabled state means a state where the remote control function is disabled such that the remote control function can be enabled again, and the irreversibly disabled state means that the remote control function is disabled such that the remote control function cannot be enabled again.

As illustrated in FIG. 5, in the present embodiment, when “enable” is selected in the remote control function selection area R4, a remote control device selection area R5 is displayed on the order screen TG. The remote control device selection area R5 displays buttons for selecting whether or not to purchase the remote control device 400 for remotely controlling the vehicle 300. When “purchase” is selected, the remote control device 400 is ordered when the vehicle 300 is ordered. When “not purchase” is selected, the remote control device 400 is not ordered when the vehicle 300 is ordered.

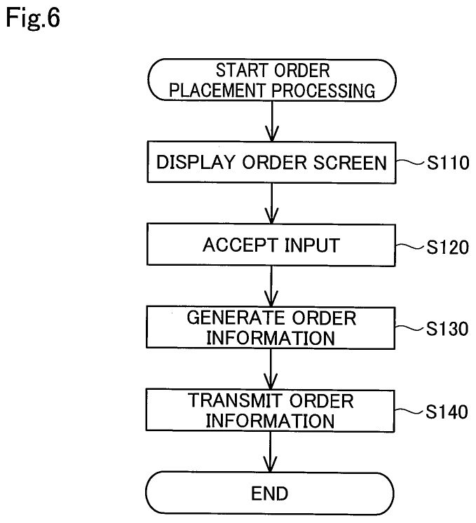

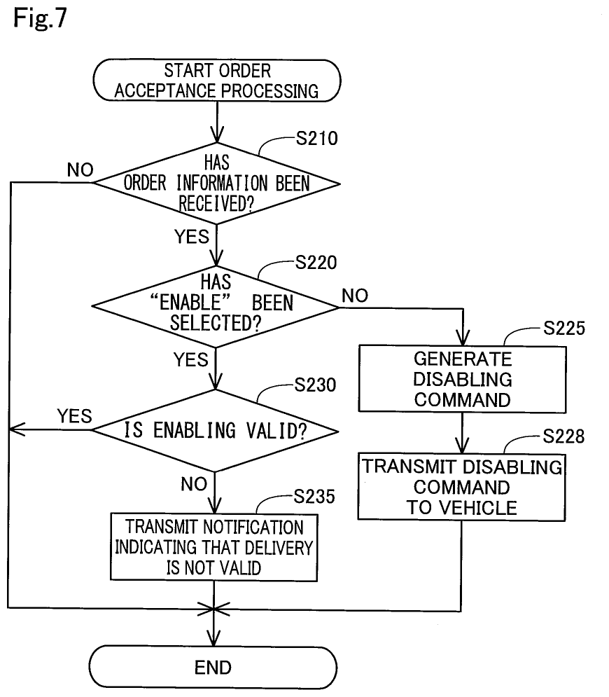

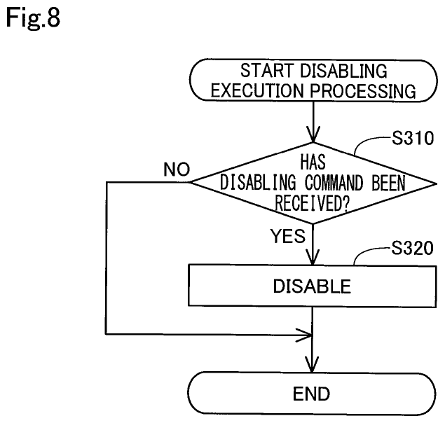

FIG. 6 is a flowchart illustrating contents of order placement processing executed by the order placement device 100. FIG. 7 is a flowchart illustrating contents of order acceptance processing executed by the order acceptance device 200. FIG. 8 is a flowchart illustrating contents of disabling execution processing executed by the vehicle 300. An order placement/order acceptance method executed by the order placement/order acceptance system 10 will be described with reference to FIGS. 6 to 8.

The order placement processing illustrated in FIG. 6 is started when a predetermined start operation is performed on the order placement device 100. When the order placement processing is started, the display control unit 110 causes the display device 106 to display the order screen TG in step S110. In step S120, the display control unit 110 accepts input of order contents through the order screen TG. In step S130, the generation unit 120 generates order information according to the order contents input to the order screen TG. In step S140, the transmission unit 130 transmits the order information to the order acceptance device 200. Then, the order placement device 100 finishes the order placement processing. Note that a method executed by the order placement processing is also referred to as an order placement method.

Order acceptance processing illustrated in FIG. 7 is repeatedly executed by the order acceptance device 200. When the order acceptance processing is started, the reception unit 210 determines in step S210 whether or not the order information has been received. In a case where it is not determined in step S210 that the order information has been received, the order acceptance device 200 finishes the order acceptance processing. In a case where it is determined in step S210 that the order information has been received, the reception unit 210 determines in step S220 whether or not “enable” has been selected for an item included in the order information and related to the remote control function of the vehicle 300.

In a case where it is determined in step S220 that “enable” has not been selected, the order information is supplied from the reception unit 210 to the disabling command unit 230, and, in step S225, the disabling command unit 230 generates a disabling command for disabling the remote control function of the vehicle 300 matching the order. The disabling command unit 230 generates a disabling command for reversibly disabling the remote control function in a case where it is determined that “disable (reversible)” has been selected, and generates a disabling command for irreversibly disabling the remote control function in a case where “disable (irreversible)” has been selected. In step S228, the disabling command unit 230 transmits the disabling command to the vehicle 300 matching the order. In the present embodiment, the order acceptance device 200 has a function of managing manufacturing of the vehicle 300 in the factory, and consequently can specify the vehicle 300 matching the order. Then, the order acceptance device 200 finishes the order acceptance processing.

In a case where it is determined in step S220 that “enable” has been selected, the order information is supplied from the reception unit 210 to the determination unit 220, and, in step S230, the determination unit 220 determines whether or not delivery of the vehicle 300 in the state where the remote control function is enabled is valid. In the present embodiment, the determination unit 220 determines whether or not delivery is valid using the database DB stored in the memory 202. More specifically, identification information of clients who have purchase records of the remote control devices 400 manufactured by the manufacturer of the vehicles 300 is registered in the database DB, and the determination unit 220 determines that delivery is valid in a case where identification information of a client included in the order information is registered in the database DB as the client who has the purchase record of the remote control device 400. In a case where identification information of a client included in the order information is registered in the database DB as the client who has the purchase record of the remote control device 400, the determination unit 220 determines whether or not delivery is valid using information that is an index related to whether or not the client can appropriately operate remote control of the vehicle 300 among information related to the client included in the order information. In a case where, for example, a client who purchases the vehicle 300 is a corporate client, the determination unit 220 determines that delivery is valid in a case where a client size or the like (the number of members, a location, a date of establishment, a capital, and the like) satisfies a predetermined condition, and determines that delivery is not valid in a case where the predetermined condition is not satisfied. In a case where a client who has made an order is an individual client, the determination unit 220 determines that delivery is valid in a case where the age, an address, and family members of the client satisfies a predetermined condition, and determines that delivery is not valid in a case where the predetermined condition is not satisfied. Information related to sizes of the corporate clients or the like, and information related to the ages of individual clients or the like can be input from the order placement device 100. In a case where it is determined in step S230 that delivery is valid, the order acceptance device 200 finishes the order acceptance processing. In a case where it is not determined in step S230 that delivery is valid, the determination unit 220 transmits a notification indicating that delivery is not valid to the order placement device 100 in step S235, and then finishes the order acceptance processing. In this case, the order placement device 100 causes the display device 106 to display a notification screen for transmitting a notification indicating that it is determined that delivery is not valid.

Disabling execution processing illustrated in FIG. 8 is repeatedly executed by the disabling execution unit 355 of the vehicle 300 while remote control of the vehicle 300 is enabled. When the disabling execution unit processing is started, the disabling execution unit 355 determines in step S310 whether or not the disabling command has been received. In a case where it is not determined in step S310 that the disabling command has been received, the disabling execution unit 355 finishes the disabling execution processing. In a case where it is determined in step S310 that the disabling command has been received, the disabling execution unit 355 disables the remote control function in step S320. In the present embodiment, the disabling execution unit 355 stops accepting the remote control command when receiving the disabling command for reversibly disabling the remote control function, and deletes a remote control program from the memory 352 of the vehicle control device 350 when receiving a disabling command for irreversibly disabling the remote control function. When reversibly disabling remote control, the disabling execution unit 355 may make the remote control unusable as long as whether or not an authority to enable the remote control is obtained has been cleared. In a case where a relay that is irreversibly opened or closed is provided between the vehicle control device 350 and the communication device 340, the disabling execution unit 355 may irreversibly disable the remote control by opening or closing the relay and blocking connection between the vehicle control device 350 and the communication device 340. The disabling execution unit 355 may irreversibly disable the remote control by burning a circuit with a current. In the present embodiment, the GNSS receiver 360 is mounted on the vehicle 300, and a memory of the vehicle control device 350 stores geofence information indicating a range of a geofence area. The geofence area is an area surrounded by a geofence that is a virtual fence. In the present embodiment, the geofence is provided surrounding the factory KJ. The disabling execution unit 355 determines whether or not the vehicle 300 is located outside the geofence area using position information and the geofence information obtained from the GNSS receiver 360, and disables the remote control function when determining that the vehicle 300 is located outside the geofence area. Then, the disabling execution unit 355 finishes the disabling execution processing.

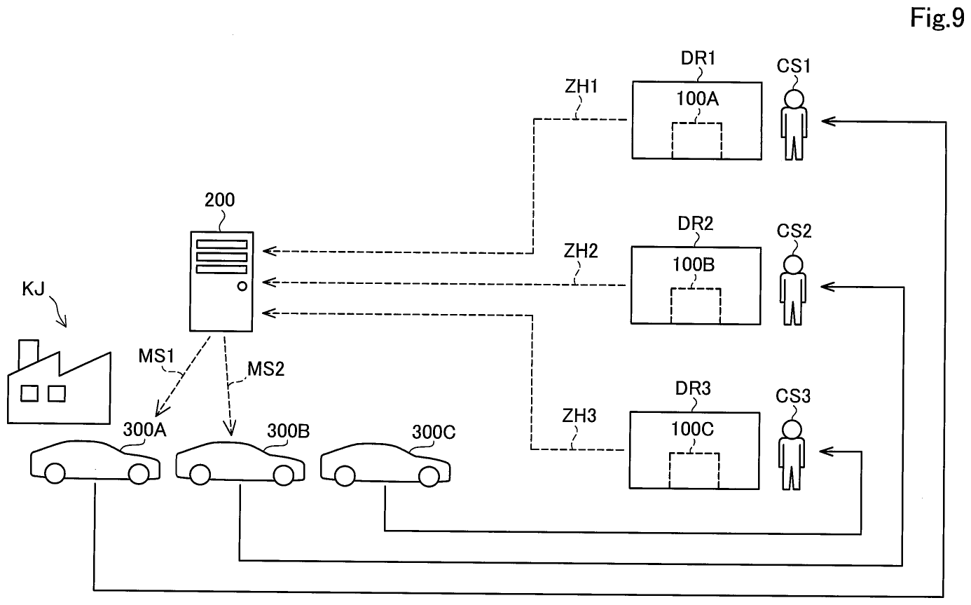

FIG. 9 is an explanatory view schematically illustrating how the vehicle 300 is ordered and delivered to a dealer. A dealer DR1 that has accepted from a client CS1 the order of the vehicle 300 in a state where the remote control function is irreversibly disabled selects “disable (irreversible)” on an order screen TG of an order placement device 100A, and the order placement device 100A transmits order information ZH1 to the order acceptance device 200. The factory KJ manufactures the vehicle 300A according to the order information ZH1. The vehicle 300A transmits a disabling command MS1 for irreversibly disabling the remote control function. The vehicle 300A for which the remote control function has been irreversibly disabled is delivered to the dealer DR1, and is handed over to the client CS1.

A dealer DR2 that has accepted from a client CS2 the order of the vehicle 300 in a state where the remote control function is reversibly disabled selects “disable (reversible)” on the order screen TG of an order placement device 100B, and the order placement device 100B transmits order information ZH2 to the order acceptance device 200. The factory KJ manufactures the vehicle 300B according to the order information ZH2. The vehicle 300B transmits a disabling command MS2 for reversibly disabling the remote control function. The vehicle 300B for which the remote control function has been reversibly disabled is delivered to the dealer DR2, and is handed over to the client CS2.

A dealer DR3 that has accepted from a client CS3 the order of the vehicle 300 in a state where the remote control function is enabled selects “enable” on the order screen TG of an order placement device 100C, and the order placement device 100C transmits order information ZH3 to the order acceptance device 200. The client CS3 is, for example, a corporate body that runs a park, a college, or an airport, and purchases the vehicle 300 to run on a regular route in the park, the college, or the airport by remote control. The factory KJ manufactures a vehicle 300C according to the order information ZH3. The vehicle 300C in a state where the remote control function is enabled is delivered to the dealer DR3, and is handed over to the client CS3. When “purchase” of the remote control device 400 is selected on the order screen TG of the order placement device 100C, the vehicle 300C and, in addition, the remote control device 400 are manufactured, and the vehicle 300C and the remote control device 400 are delivered to the dealer DR3 and handed over to the client CS3.

According to the order placement/order acceptance system 10 according to the above-described present embodiment, the display control unit 110 of the order placement device 100 causes the display device 106 to display the order screen TG that enables selection of the state of the remote control function of the vehicle 300 at the time of delivery from three of “enable”, “disable (reversible)”, and “disable (irreversible)”. Consequently, it is possible to provide to the client the vehicle 300 in a state that meets a client's demand.

Furthermore, in the present embodiment, in a case where “enable” is selected on the order screen TG, it is possible to select “purchase” of the remote control device 400 on the order screen TG. Consequently, it is possible to provide the vehicle 300 and, in addition, the remote control device 400 for remotely controlling the vehicle 300 to the client.

Furthermore, in the present embodiment, the determination unit 220 of the order acceptance device 200 determines whether or not to accept an order for which “enable” has been selected. The determination unit 220 determines that the order is accepted in a case where identification information of a client included in the order information is registered in the database DB as the client who has the purchase record of the remote control device 400. Consequently, it is possible to provide the vehicle 300 in a state where the remote control function is enabled only to a client for whom delivery of the vehicle 300 in the state where the remote control function is enabled is permitted as a person who can appropriately operate the remote control function of the vehicle 300. Furthermore, the determination unit 220 determines whether or not the client is a person who can appropriately operate remote control using various pieces of information related to the client in a case where a client who purchases the vehicle 300 is not registered in the database DB, and determines to accept an order when determining that the client is determined as the person who can appropriately operate remote control. Consequently, it is possible to provide the vehicle 300 in the state where the remote control function is enabled only to a client who is certified as a person who can appropriately operate remote control.

Furthermore, in the present embodiment, when “disable (reversible)” is selected on the order screen TG, the order acceptance device 200 who has received order information transmits to the vehicle 300 a disabling command for reversibly disabling the remote control function, and, when “disable (irreversible)” is selected on the order screen TG, the order acceptance device 200 that has received the order information transmits to the vehicle 300 a disabling command for irreversibly disabling the remote control function. The vehicle 300 that has received the disabling command reversibly disables or irreversibly disables the remote control function according to the disabling command. Consequently, it is possible to automatically disable the remote control function of the vehicle 300 according to the order contents of the vehicle 300.

### B. Other Embodiment

(B1) In the order placement/order acceptance system 10 according to the above-described first embodiment, the disabling execution unit 355 disables the remote control function of the vehicle 300 when determining that the vehicle 300 is located outside the geofence area. By contrast with this, the vehicle 300 may include a timer, and the disabling execution unit 355 may disable the remote control function of the vehicle 300 at a timing at which the timer detects that a predetermined period passes after the disabling command is received. In this case, it is possible to adjust the timing at which the remote control function of the vehicle 300 is disabled.

(B2) In the order placement/order acceptance system 10 according to the above-described first embodiment, a laser oscillator that oscillates laser light of a predetermined wavelength is installed in the factory KJ, the vehicle 300 includes a detector that detects the laser light of the above wavelength, and the disabling execution unit 355 may disable the remote control function of the vehicle 300 at a timing at which the detector detects the laser light. In this case, it is possible to disable the remote control function of the vehicle 300 at a timing at which the vehicle 300 passes a place at which the laser oscillator is installed. Note that an electromagnetic wave other than the laser light may be used to disable the remote control function of the vehicle 300. For example, a microwave may be used to disable the remote control function of the vehicle 300.

(B3) In the order placement/order acceptance system 10 according to the above-described first embodiment, the vehicle 300 may include a communication device that communicates with other vehicles located in the surroundings of the own vehicle, the vehicle 300 may be configured to transmit signals to the other vehicles when the remote control function of the own vehicle is disabled, and the disabling execution unit 355 may disable the remote control function of the own vehicle at a timing at which signals are received from the other vehicles. In this case, it is possible to collectively disable the remote control functions of the plurality of vehicles 300 by disabling the remote control function of one of the plurality of vehicles 300.

(B4) In the order placement/order acceptance system 10 according to the above-described first embodiment, when “enable” is selected in the remote control function selection area R4 of the order screen TG, the remote control device selection area R5 is displayed on the order screen TG. By contrast with this, the remote control device selection area R5 may not be displayed on the order screen TG.

(B5) In the order placement/order acceptance system 10 according to the above-described first embodiment, when “disable (reversible)” is selected in the remote control function selection area R4 of the order screen TG, buttons for selecting whether or not to purchase a device that resets the remote control function to the enabled state may be displayed on the order screen TG. In this case, it is possible to provide a device that resets the remote control function of the vehicle 300 to the enabled state to a client who purchases the vehicle 300 whose remote control function has been reversibly disabled.

(B6) In the order placement/order acceptance system 10 according to the above-described first embodiment, when the order information indicates that “disable (reversible)” has been selected, the remote control function of the vehicle 300 is reversibly disabled, and, when the order information indicates that “disable (irreversible)” has been selected, the remote control function of the vehicle 300 is irreversibly disabled. By contrast with this, the manufacturing process of the vehicle 300 includes a process of reversibly disabling the remote control function of the vehicle 300, and, when the order information indicates that “enable” has been selected, the remote control function of the vehicle 300 may be enabled.

(B7) In the order placement/order acceptance system 10 according to the above-described first embodiment, the determination unit 220 is provided to the order acceptance device 200. By contrast with this, the determination unit 220 may be provided to the order placement device 100 instead of the order acceptance device 200. In this case, in order placement processing, the determination unit 220 of the order placement device 100 may determine whether or not delivery of the vehicle 300 in a state where the remote control function of the vehicle 300 is enabled is valid prior to transmission of the order information to the order acceptance device 200. The determination unit 220 may transmit the order information to the order acceptance device 200 when determining that the delivery is valid, and cause the display device 106 to display a notification screen for transmitting a notification indicating that the delivery is not valid when determining that the delivery is not valid. Furthermore, the order placement/order acceptance system 10 may not be provided with the determination unit 220.

(B8) In the above-described first embodiment, the vehicle 300 may be sold in a form of a platform, and a client may finish the vehicle 300 that has been purchased as the form of the platform as a finished vehicle. In this case, the client can move the vehicle 300 by causing the vehicle 300 to run in an own factory by remote control without using a conveyance device such as a crane or a conveyor.

(B9) In the above-described first embodiment, the external sensor is not limited to the camera but may be the distance measuring device, for example. The distance measuring device is a light detection and ranging (LiDAR) device, for example. In this case, detection result output from the external sensor may be three-dimensional point cloud data representing the vehicle 300. The remote control device 400 and the vehicle 300 may acquire the vehicle location information through template matching using the three-dimensional point cloud data as the detection result and reference point cloud data, for example.

(B10) In the above-described first embodiment, the remote control device 400 performs the processing from acquisition of vehicle location information to generation of a running control signal. By contrast, the vehicle 300 may perform at least part of the processing from acquisition of vehicle location information to generation of a running control signal. For example, embodiments (1) to (3) described below are applicable, for example.

(1) The remote control device 400 may acquire vehicle location information, determine a target location to which the vehicle 300 is to move next, and generate a route from a current location of the vehicle 300 indicated by the acquired vehicle location information to the target location. The remote control device 400 may generate a route to the target location between the current location and a destination or generate a route to the destination. The remote control device 400 may transmit the generated route to the vehicle 300. The vehicle 300 may generate a running control signal in such a manner as to cause the vehicle 300 to run along the route received from the remote control device 400 and control an actuator using the generated running control signal.

(2) The remote control device 400 may acquire vehicle location information and transmit the acquired vehicle location information to the vehicle 300. The vehicle 300 may determine a target location to which the vehicle 300 is to move next, generate a route from a current location of the vehicle 300 indicated by the received vehicle location information to the target location, generate a running control signal in such a manner as to cause the vehicle 300 to run along the generated route, and control an actuator using the generated running control signal.

(3) In the foregoing embodiments (1) and (2), an internal sensor may be mounted on the vehicle 300, and detection result output from the internal sensor may be used in at least one of the generation of the route and the generation of the running control signal. The internal sensor is a sensor mounted on the vehicle 300. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the remote control device 400 may acquire detection result from the internal sensor, and in generating the route, may reflect the detection result from the internal sensor in the route. In the foregoing embodiment (1), the vehicle 300 may acquire detection result from the internal sensor, and in generating the running control signal, may reflect the detection result from the internal sensor in the running control signal. In the foregoing embodiment (2), the vehicle 300 may acquire detection result from the internal sensor, and in generating the route, may reflect the detection result from the internal sensor in the route. In the foregoing embodiment (2), the vehicle 300 may acquire detection result from the internal sensor, and in generating the running control signal, may reflect the detection result from the internal sensor in the running control signal.

(B11) In the above-described first embodiment, the remote control device 400 automatically generates a running control signal to be transmitted to the vehicle 300. By contrast, the remote control device 400 may generate a running control signal to be transmitted to the vehicle 300 in response to operation by an external operator existing outside the vehicle 300. For example, the external operator may operate an operating device including a display on which a captured image output from the external sensor is displayed, steering, an accelerator pedal, and a brake pedal for operating the vehicle 300 remotely, and a communication device for making communication with the remote control device 400 through wire communication or wireless communication, for example, and the remote control device 400 may generate a running control signal responsive to the operation on the operating device.

(B12) In the above-described first embodiment, the vehicle 300 is simply required to have a configuration to become movable by unmanned driving. The vehicle 300 may embodied as a platform having the following configuration, for example. The vehicle 300 is simply required to include at least actuators and a controller. More specifically, in order to fulfill three functions including “run,” “turn,” and “stop” by unmanned driving, the actuators may include a driving device, a steering device and a braking device. The actuators are controlled by the controller that controls running of the vehicle 300. In order for the vehicle 300 to acquire information from outside for unmanned driving, the vehicle 300 is simply required to include the communication device further. Specifically, the vehicle 300 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 300 before the vehicle 300 is shipped from the factory KJ, or a remaining component such as a bodyshell may be mounted on the vehicle 300 after the vehicle 300 is shipped from the factory KJ while the remaining component such as a bodyshell is not mounted on the vehicle 300. Each of components may be mounted on the vehicle 300 from any direction such as from above, from below, from the front, from the back, from the right, or from the left. Alternatively, these components may be mounted from the same direction or from respective different directions. The location determination for the platform may be performed in the same way as for the vehicle 300 in the first embodiments.

(B13) The vehicle 300 may be manufactured by combining a plurality of modules. The module means a unit composed of one or more components grouped according to a configuration or function of the vehicle 300. For example, a platform of the vehicle 300 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 300 different from the platform may be modularized. Various modules may include an arbitrary exterior component such as a bumper or a grill, or an arbitrary interior component such as a seat or a console. Not only the vehicle 300 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(B14) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

(B15) The control and the method described in the present disclosure may be realized by a dedicated computer provided by configuring a processor and a memory programmed in such a manner as to implement one or a plurality of functions embodied by a computer program. Alternatively, the controller and the method described in the present disclosure may be realized by a dedicated computer provided by configuring a processor using one or more dedicated hardware logic circuits. Still alternatively, the controller and the method described in the present disclosure may be realized by one or more dedicated computers configured using a combination of a processor and a memory programmed in such a manner as to implement one or a plurality of functions, and a processor configured using one or more hardware logic circuits. The computer program may be stored as an instruction to be executed by a computer into a computer-readable tangible non-transitory recording medium.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof.

What is claimed is:

1. An order placement/order acceptance system comprising:
an order placement device configured to place an order of a moving object that is moved by remote control in a manufacturing process of the moving object; and
an order acceptance device configured to accept an order of the moving object,
wherein the order placement device includes a display control unit and a transmission unit,
wherein the display control unit is configured to cause a display device to display an order screen for accepting the order of the moving object, wherein the order screen enables selection of whether to desire delivery of the moving object in an enabled state or to desire the delivery of the moving object in a disabled state, wherein the enabled state is a state that the remote control is accepted, wherein the disabled state is a state that the remote control is not accepted, and
wherein the transmission unit is configured to transmit order information including contents selected via the order screen, and
wherein the order acceptance device includes a reception unit and a disabling command unit,
wherein the reception unit is configured to receive the order information, and
wherein the disabling command unit is configured to transmit to the moving object a disabling command for switching the enabled state to the disabled state, wherein when the order information indicates that the delivery of the moving object in the disabled state is desired, the disabling command unit transmits to the moving object the disabling command.

2. The order placement/order acceptance system according to claim 1, wherein, when the delivery of the moving object in the enabled state is selected, the display control unit enables selection of whether or not to order a remote control device that remotely controls the moving object on the order screen.

3. The order placement/order acceptance system according to claim 1, wherein the moving object includes a disabling execution unit configured to switch the enabled state to the disabled state, wherein when a predetermined condition including reception of the disabling command is satisfied, disabling execution unit switches the enabled state to the disabled state.

4. The order placement/order acceptance system according to claim 1, wherein the order acceptance device further includes a determination unit configured to determine whether or not to accept the order placement of the moving object, wherein when the order information indicates that the delivery of the moving object in the enabled state is desired, the determination unit determines whether or not to accept the order placement of the moving object.

5. The order placement/order acceptance system according to claim 4, wherein the determination unit determines whether or not to accept the order placement of the moving object using information related to a client who purchases the moving object.

6. The order placement/order acceptance system according to claim 4, wherein
the order acceptance device further includes a storage unit configured to store a database related to a client for whom the delivery of the moving object in the enabled state is permitted, and
the determination unit determines whether or not to accept the order placement of the moving object using the database.

7. The order placement/order acceptance system according to claim 4, wherein, when determining not to accept the order placement of the moving object, the determination unit transmits, to the order placement device, information indicating that the order placement of the moving object is not accepted.

8. The order placement/order acceptance system according to claim 3, wherein, when receiving the disabling command and then detecting that the moving object is located in a predetermined area, the disabling execution unit switches the enabled state to the disabled state.

9. The order placement/order acceptance system according to claim 3, wherein, the disabling execution unit switches the enabled state to the disabled state at a timing at which a predetermined period passes after the disabling command is received.

10. The order placement/order acceptance system according to claim 3, wherein, when receiving the disabling command and then detecting an electromagnetic wave of a predetermined wavelength, the disabling execution unit switches the enabled state to the disabled state.

11. The order placement/order acceptance system according to claim 3, wherein, when receiving the disabling command and then detecting that another moving object located in surroundings of the moving object has been switched from the enabled state to the disabled state, the disabling execution unit switches the enabled state to the disabled state.

12. An order placement device that places an order of a moving object that is moved by remote control in a manufacturing process of the moving object, the order placement device comprising:
a display control unit configured to cause a display device to display an order screen for accepting the order of the moving object, wherein the order screen enables selection of whether to desire delivery of the moving object in an enabled state or to desire the delivery of the moving object in a disabled state, wherein the enabled state is a state that the remote control is accepted, wherein the disabled state is a state that the remote control is not accepted; and
a transmission unit configured to transmit order information including contents selected via the order screen to an order acceptance device that accepts the order of the moving object.

13. An order placement method for placing an order of a moving object that is moved by remote control in a manufacturing process of the moving object, the order placement method comprising:
causing a display device to display an order screen for accepting the order of the moving object, wherein the order screen enables selection of whether to desire delivery of the moving object in an enabled state or to desire the delivery of the moving object in a disabled state, wherein the enabled state is a state that the remote control is accepted, wherein the disabled state is a state that the remote control is not accepted; and
transmitting order information including contents selected via the order screen to an order acceptance device that accepts the order of the moving object.
